(19) United States
(12) Patent Application Publication
(10) Pub. No.: US 2002/0126665 A1
(43) Pub. Date: Sep. 12, 2002

(54) Wireless lan system and method for the same

(75) Inventor: Tsukasa Ueno, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/087,746

(22) Filed: Mar. 5, 2002

(30) Foreign Application Priority Data
Mar. 9, 2001 (JP) 2001-06694

(51) Int. Cl. H04L 12/56

(52) U.S. Cl. 370/389; 370/386

(57) ABSTRACT

In the base station BS₁, BS₂, BS₃, BS₄, agent information such as the IP address of the agent AG₁, AG₂ is stored based on an agent advertisement running on the network NW₁, NW₂. A belonging request from the mobile terminal MT₁, MT₂, MT₃, MT₄ is stored. When the belonging of the mobile terminal MT₁, MT₂, MT₃, MT₄ is permitted, the agent information to be stored is transmitted to the mobile terminal MT₁, MT₂, MT₃, MT₄, together with permission for belonging.

### BACKGROUND OF THE INVENTION

The present invention relates to a wireless LAN system and a method for the same, wherein a mobile terminal connects is wirelessly connected to a network so that communications are conducted. Particularly, the present invention relates to a wireless LAN system and a method for the same, wherein communications can be seamlessly maintained while a mobile terminal is moving between the wireless cells of respective base stations connected to a network.

In the wireless LAN system that allows a mobile terminal to be connected wirelessly to a communication network while the mobile terminal is freely moving, an agent on the communications network manages the location of a mobile terminal. To manage the location of a mobile terminal, an agent has to register the location of the mobile terminal.

There are two methods to catalog locations on an agent. That is, one is the method in which a mobile terminal receives the frame of an agent advertisement periodically sent from an agent to catalog the location thereof. The other is the method in which a mobile terminal itself detects an agent to catalog the location thereof. Generally, in comparison with the latter, the former can more shorten the time period until a mobile terminal establishes communications with the network.

FIG. 4 is a block diagram illustrating the configuration of a wireless LAN system applied when an agent periodically sends an agent advertisement. Referring to FIG. 4, the wireless LAN system includes a router R₁, networks NW₁ and NW₂, base stations BS₁ to BS₄, agents AD₁ and AG₂, and mobile terminals MT₁ to MT₄. Each of the networks NW₁, and NW₂ is, for example, Ethernet. The router R₁ connects the network NW₁, and the network NW₂.

The networks BS₁, and BS₂ are in the network NW₁. The networks BS₃ and BS₄ are in the network NW₂. The radio cells C₁ to C₄ belong to the base terminals BS₁ to BS₄, respectively. When the mobile terminal MT₁, MT₂, MT₃, or MT₄ is within any one of the radio cells C₁ to C₄, respectively belonging to the base stations BS₁ to BS₄, it is connected to the base station in the corresponding radio cell. Thus the corresponding mobile terminal conducts IP (Internet Protocol) communications via the corresponding base station. As shown in FIG. 4, when being within the radio area C₁ of the base station BS₁, the mobile terminal MT₁ is linked to the base station BS₁, thus conducting communications via the base station BS₁.

The agent AG₁ belongs to the network NW₁ while the agent AG₂ belongs to the network NW₂. In order to perform the IP mobility support or location management of a mobile terminal connected to the base station BS₁, BS₂ in the corresponding network, the agent AG₁ periodically sends an agent advertisement frame to all the base stations BS₁ and BS₂ connected to the network NW₁. In order to perform the IP mobility support or location management of a mobile terminal connected to the base station BS₃, BS₄ in the corresponding network, the agent AG₂ periodically sends an agent advertisement frame to all the base stations BS₃ and BS₄ connected to the network NW₂. Each of the base stations BS₁, BS₂, BS₃, and BS₄ sends an agent advertisement frame within its radio area.

When moving from the radio area C₁ of the base station BS₁ to the radio area C₃ of the base station BS₃, the mobile terminal MT₁ detects its movement because communications to the base station BS₁ are interrupted. Subsequently, the mobile terminal MT₁ newly performs a belonging sequence process to the base station BS₃ and then waits for an agent advertisement issued from the base station BS₃. When receiving the agent advertisement, the mobile terminal MT₁ changes the setting of the internal network and notifies the agent AG₁ of the movement. When receiving the notice of the movement, the agent AG₁ registers the mobile terminal MT₁ to manage the location of the mobile terminal MT₁.

Recently, it has been required that the wireless LAN system quickly can switch from a base station to another base station in accordance with movement of a mobile terminal to more shorten the instantaneous disconnection of communications. The various technologies to solve the above-mentioned demand are disclosed in JP-A No. 56473/1998, JP-A No. 56475/1998, JP-A No. 92562/2000, and Japanese Patent No. 3001490. In order to switch over from a base station to another base station in accordance with movement of a mobile terminal, the mobile terminal first receives an agent advertisement periodically transmitted from an agent. Next, after the mobile terminal transmits a movement notice to the agent, the agent registers the mobile terminal based on the movement notice. To shorten the base station switching time, the time period required for the above-mentioned process has to be reduced. However, the problem is that even if the above-mentioned technologies are combined together, the processing time cannot be shortened.

As described above, to shorten disconnection of communications more quickly, it is required that the conventional wireless LAN system quickly changes a base station to another base station in accordance with movement of a mobile station. However, because the method has not been proposed of shortening the time required to enter a mobile terminal in an agent, the problem is that the base station switching time cannot be shortened.

### SUMMARY OF THE INVENTION

An abject of the present invention is to provide a wireless LAN system and a wireless LAN system control method, that can shorten the time period during which a base station is switched to another base station.

In order to solve the above-mentioned problem, a wireless LAN system of the invention comprises a plurality of communications networks connected to each other; wireless base stations for periodically transmitting a signal within a wireless cell, at least one of the wireless base stations being disposed in each of the networks; a mobile terminal for transmitting, when newly receiving the signal, a belonging request to a wireless base station which has transmitted the signal and connecting, when receiving permission for belonging from the wireless base station, the mobile terminal to the wireless base station, thus conducing communications; and agents each for distributing an agent advertisement onto the communications networks and managing, after the mobile terminal receives the agent information, the location of the mobile terminal based on movement information transmitted from the mobile terminal, each of agents being disposed in each of the communications networks. Each of the base stations stores the agent information based on the agent advertisement distributed onto the communications network, receives a belonging request from the mobile terminal, and transmits, when belonging of the mobile terminal is permitted, the agent information to the mobile terminal to be stored, together with the permission for belonging.

In the wireless LAN system according to the present invention, a wireless base station stores an agent advertisement transmitted from an agent. Thus, when a mobile terminal tries to establish connection, the wireless base station can immediately transmit the agent advertisement. For that reason, the wireless LAN system does not require that a mobile terminal stands by until an agent transmits an agent advertisement. Therefore, according to the present invention, the wireless LAN system can shorten the time period required to enter the location of a mobile terminal in an agent, that is, the wireless-base-station changeover time.

### BRIEF DESCRIPTION OF THE DRAWINGS

This and other objects, features and advantages of the present invention will become more apparent upon a reading of the following detailed description and drawings, in which:

FIG. 1 is a block diagram illustrating the configuration of a wireless LAN system according to an embodiment of the present invention;

FIG. 2 is a block diagram illustrating the configuration of a base station in a wireless LAN system according to an embodiment of the present invention;

FIG. 3 is a block diagram illustrating the configuration of a wireless terminal in a wireless LAN system according to an embodiment of the present invention and

FIG. 4 is a block diagram illustrating the configuration of a conventional wireless LAN system.

### DESCRIPTION OF THE EMBODIMENTS

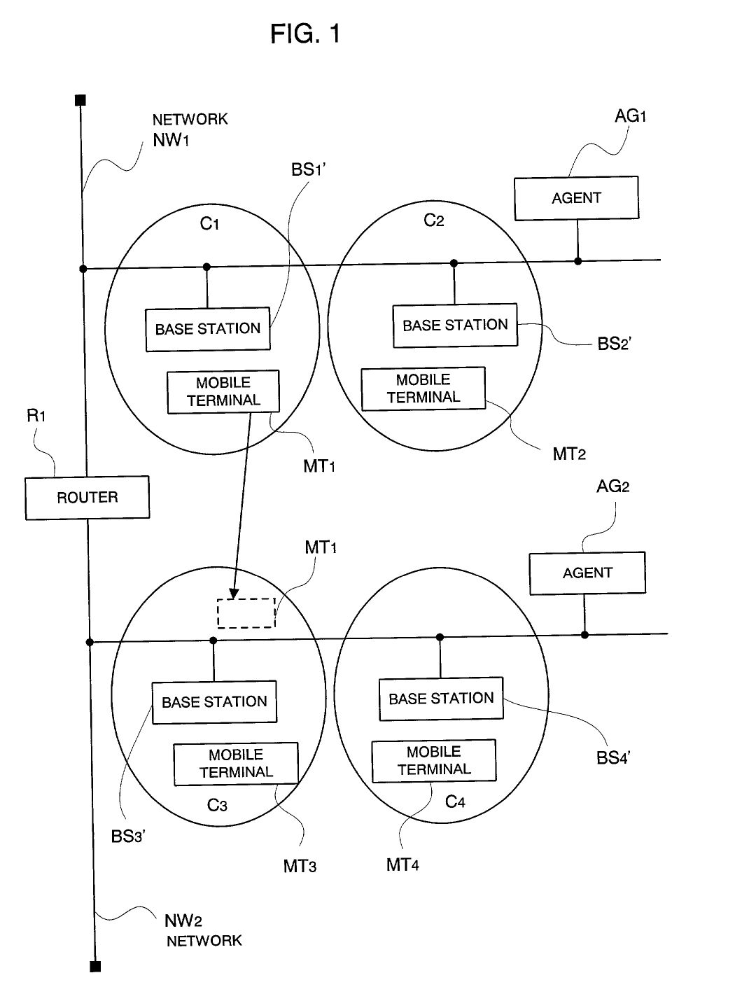

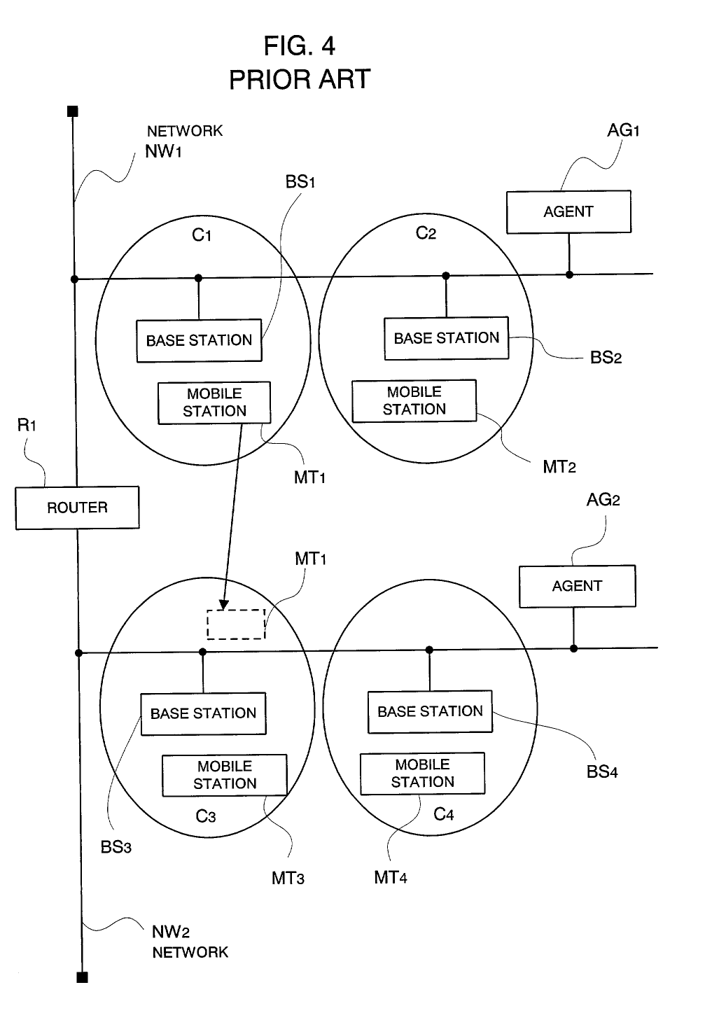

A wireless LAN system and the control method thereof, according to the present invention, will be described below in detail by referring to the attached drawings. FIG. 1 is a block diagram illustrating the configuration of a wireless LAN system according to an embodiment. Referring to FIG. 1, the wireless LAN system differs from the conventional wireless LAN system shown in FIG. 4 in that base stations BS₁′ to BS₄′ are included in place of the base stations BS₁ to BS₄.

Each of the base stations BS₁′ and BS₂′ always monitors an agent advertisement frame periodically sent onto the network NW₁ from agent AG₁. Each of the base stations BS₃′ and BS₄′ always monitors an agent advertisement frame periodically sent onto the network NW₂ from agent AG₂. Each of the base stations BS₁′ to BS₄′ receives and stores the frame.

Each of the base stations BS₁′ to BS₄′ receives a belonging request from a mobile terminal newly entered into the radio cell thereof. When belonging is allowable, the base station notifies the mobile terminal of permission for belonging while it transmits a stored agent advertisement frame to the mobile terminal.

As shown in FIG. 1, when the mobile terminal MT₁ moves from the radio area C₁′ of the base station BS₁′ to the radio area C₃′ of the base station BS₃′, the mobile terminal MT₁′ newly transmits a belonging request to the base station BS₃′. Meanwhile, the mobile terminal MT₁′, waits for reception of an agent advertisement frame. Because an agent advertisement transmitted from the agent has been already stored, the base station BS₃′ transmits the agent advertisement to the mobile terminal MT₁.

In a manner similar to that in the prior art, the mobile terminal MT₁ changes the network setting of the agent AG₂ based on the agent advertisement transmitted from the base station BS₃′ and transmits a movement notice for the agent AG₂ to the base station BS₃′.

As described above, in the wireless LAN system of the present embodiment, each of the base stations BS₁′ to BS₄′ stores agent advertisements transmitted from the agents AG₁ and AG₂. Thus, when the mobile terminal MT₁, M₂, M₃, MT₄, tries to establish connection, the base station can immediately transmit the agent advertisement. For that reason, in the wireless LAN system, it is not required that the mobile terminal MT₁, MT₂, MT₃, MT₄ waits until the agent AG₁, AG₂ transmits an agent advertisement. As a result, the time period required to catalog the mobile terminal MT₁, MT₂, MT₃, MT₄ in the agent AG₁, AG₂ can be shortened. The wireless LAN system can shorten the time period during which base stations BS₁′ to BS₄′ are switched over, thus shortening instantaneous disconnection of communications.

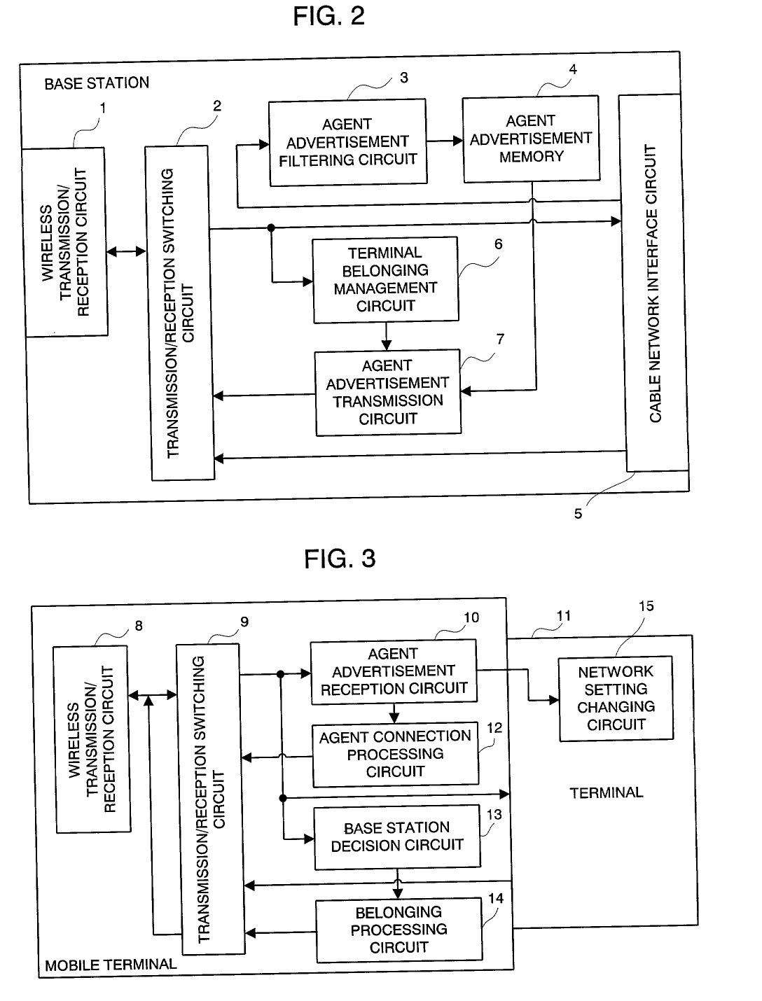

FIG. 2 is a block diagram illustrating the configuration of a base station BS₁′, BS₂′, BS₃′, BS₄′ in a wireless LAN system of the present embodiment. Referring to FIG. 2, each of the base stations BS₁′ to BS₄′ includes a wireless transmission/reception circuit 1, a transmission/reception switching circuit 2, an agent advertisement filtering circuit 3, an agent advertisement memory 4, a cable network interface circuit 5, a terminal belonging management circuit 6, and an agent advertisement transmission circuit 7. A bi-directional transmission/reception line, which is used in communications between a mobile terminal and a communication destination, is inserted between the transmission switching circuit 2 and the cable network interface circuit 5.

The base station BS₁′, BS₂′, BS₃′, BS₄′, is linked to a network via the cable network interface circuit 5. The cable network interface circuit 5 monitors an agent advertisement frame periodically sent from an agent and then outputs a received agent advertisement to the agent advertisement memory 4 via the agent advertisement filtering circuit 3. The agent advertisement filtering circuit 3 filters signals on the network and extracts an agent advertisement frame. The agent advertisement memory 4 stores the agent advertisement extracted by the agent filtering circuit 3.

The wireless transmission/reception circuit 1 is an interface circuit that connects a mobile terminal to a base station by wireless. The transmission/reception switching circuit 2 switches over between wireless transmission and wireless reception. A base station implements wireless transmission/reception to a mobile terminal, using the wireless transmission/reception circuit 1 and the transmission/reception switching circuit 2. For example, the CSMA/CA scheme is used as the wireless communications scheme of the wireless station.

The terminal belonging management circuit 6 detects that a belonging request is transmitted from a mobile terminal. When detecting that a belonging process is performed to a mobile terminal, the terminal belonging management circuit 6 notifies the agent advertisement transmission circuit 7 of the detection. In response to the notice, the agent advertisement transmission circuit 7 reads out an agent advertisement from the agent advertisement memory 4 and transmits the agent advertisement to the mobile terminal via the wireless transmission/reception circuit 1 and via the transmission/reception switching circuit 2.

FIG. 3 is a block diagram illustrating the configuration of a mobile terminal in a wireless LAN system according to an embodiment. Referring to FIG. 3, a mobile terminal includes a wireless transmission/reception circuit 8, a transmission/reception switching circuit 9, an agent advertisement reception circuit 10, an agent connection processing circuit 12, a base station decision circuit 13, and a belonging processing circuit 14. The terminal 11, which is, for example, a notebook-size personal computer to be connected to a mobile terminal, has a network setting changing circuit 15. A bidirectional transmission/reception circuit used when the terminal 11 communicates with a communication destination on a network is inserted between the transmission/reception switching circuit 9 and the terminal 11.

The wireless transmission/reception circuit 8 is an interface circuit that connects a mobile terminal to a base station by wireless. The transmission/reception switching circuit 9 switches over between wireless transmission and wireless reception by wireless transmission/reception circuit 8. A mobile terminal conducts wireless transmission/reception between the mobile terminal and a base station, using the wireless transmission/reception circuit 8 and the transmission/reception switching circuit 9. As the wireless LAN communications scheme of the base station, there is, for example, the CSMA/CA scheme.

The base station decision circuit 13 detects signals (e.g. beacon) periodically transmitted from a base signals are not detected, the base station decision circuit 13 judges that the self station has moved out from the radio cell of the base station. Moreover, when detecting signals periodically transmitted from other base station, the base station decision circuit 13 notifies the belonging processing circuit 14 of the detection. When receiving the notice, the belonging processing circuit 14 transmits a belonging request signal to the base station via the wireless transmission/reception circuit 8 and via the transmission/reception switching circuit 9.

The agent advertisement reception circuit 10 detects reception of an agent advertisement. When detecting reception of an agent advertisement, the agent advertisement reception circuit 10 notifies the agent connection processing circuit 12 of the detection. Meanwhile, the agent advertisement reception circuit 10 outputs a request to the network setting changing circuit 15 to change the network setting of the terminal 11 based on the agent advertisement information. When receiving the notice saying that reception of an agent advertisement has been detected, the agent connection processing circuit 12 transmits a movement notice for an agent to the base station via the wireless transmission/reception circuit 8 and via the transmission/reception switching circuit 9.

When receiving a request for changing the network setting, the network setting changing circuit 15 in the terminal 11 changes the network setting of the terminal 11 in accordance with the request. For example, in the mobile terminal, when each of the networks NW₁ and NW₂ shown in FIG. 1 is a communications network conducting communications with the TCP/IP, an agent advertisement transmitted by each agent stores the IP address of an agent. As shown in FIG. 1, when a mobile terminal is handed over from the base station BS₁′ to the base station BS₃′ or is connected to a base station in a different network, the agent advertisement reception circuit 10 notifies the network setting changing circuit 15 of the IP address of an agent contained in the agent advertisement, together with a network setting changing request. The network setting changing circuit 15 changes the IP address notified of the setting of the IP address of an agent.

In the mobile terminal in the wireless LAN system of the present embodiment, when a standard mobile IP is supported in the TCP/IP module of the terminal 11, the agent advertisement reception circuit 10 and the agent connection processing circuit 12 are disposed as described above. In such a configuration, the current agent can be quickly grasped without changing the mobile IP process. When the terminal 11 has the function of the agent advertisement reception circuit 10 and the function of the agent connection processing circuit 12, it is not required to prepare the agent advertisement reception circuit 10 and the agent connection processing circuit 12 in the mobile terminal.

In the wireless LAN system of the present embodiment, the base station BS₁′ transmits an agent advertisement itself to a mobile terminal. However, the present should not be limited only to the wireless LAN system of the embodiment. The base station may transmit to a mobile terminal only valuable information such as the IP address of an agent of information contained in an agent advertisement. In such a case, the traffic volume between the base station and the mobile terminal is more decreased so that the radio band can be utilized effectively.

The base stations are completely stationary. When grasping the installation place, a network administrator may set the IP address of an agent in the network to the base station, using SNMP (Simple Network Management Protocol). SNMP means a network management protocol in the TCP/IP. In such a configuration, the radio band between a base station and a wireless station can be effectively utilized. Because the agent advertisement filtering circuit 3 is reduced in the configuration of the base station in FIG. 2, the configuration of the base station can be more simplified.

As described above, the wireless LAN system and the method thereof according to the present invention have the following advantages.

1. A wireless base station stores an agent advertisement transmitted from an agent. Thus, when a mobile terminal tries to establish connection, the wireless base station can immediately transmit the agent advertisement. This does not require that the mobile station waits for the agent advertisement transmitted from the agent for a long time. Therefore, the wireless LAN system can shorten the time required to catalog an agent advertisement in the agent, that is, the wireless station changeover time, thus decreasing the communication disconnection time.

2. A base station is not required to periodically originate an agent advertisement to radio cells. This enables to lessen the traffic volume between a base station and a wireless station. Thus, the wireless band can be effectively utilized.

3. When a standard mobile IP is supported in the TCP/IP module, a mobile terminal includes, for example, an agent advertisement reception circuit and an agent connection processing circuit. Thus, the current agent can be quickly grasped without changing the mobile IP process.

What is claimed is:

1. A wireless LAN system comprising:
a plurality of communications networks connected to each other;
wireless base stations for periodically transmitting a signal within a wireless cell, at least one of said wireless base stations being disposed in each of said networks;
a mobile terminal for transmitting, when newly receiving said signal, a belonging request to a wireless base station which has transmitted said signal and connecting, when receiving permission for belonging from said wireless base station, said mobile terminal to said wireless base station, thus conducing communications; and
agents each for distributing an agent advertisement onto said communications networks and managing, after said mobile terminal receives said agent information, the location of said mobile terminal based on movement information transmitted from said mobile terminal, each of agents being disposed in each of said communications networks;
each of said base stations storing said agent information based on said agent advertisement distributed onto said communications network, receiving a belonging request from said mobile terminal, and transmitting, when belonging of said mobile terminal is permitted, said agent information to said mobile terminal to be stored, together with said permission for belonging.

2. The system defined in claim 1, wherein said agent information comprises said agent advertisement.

3. The system defined in claim 2, wherein said wireless base station comprises:
an agent advertisement filtering circuit for filtering signals on said communications networks and then extracting said agent advertisement;
an agent advertisement memory for storing an agent advertisement output from said agent advertisement filtering circuit;
a cable network interface circuit for monitoring an agent advertisement distributed on said communications networks and outputting said signals on said communications networks into said agent advertisement filtering circuit;
a wireless transmission/reception circuit for being an interface circuit that connects said wireless base station to said mobile terminal by wireless;
a transmission/reception switching circuit for changing said wireless transmission/reception circuit to a transmission mode or a reception mode;
an agent advertisement transmission circuit for reading, when receiving a notice from said mobile terminal saying that a belonging request has been received, said agent advertisement from said agent advertisement memory, and then transmitting said notice to said mobile terminal via said wireless transmission/reception circuit and via said transmission/reception switching circuit; and
a terminal belonging management circuit for notifying, when detecting receiving a belonging request from said mobile terminal, said agent advertisement transmission circuit of the reception.

4. The system defined in claim 1, wherein said agent information contains at least an IP address of said agent.

5. The system defined in claim 4, wherein said wireless base station comprises:
a memory for storing said agent information set via said communications networks using a SNMP;
a cable network interface circuit for outputting said agent information received, to said memory;
a wireless transmission/reception circuit being an interface circuit that connects said wireless base station to said mobile terminal by wireless;
a transmission/reception switching circuit for switching said wireless transmission/reception circuit to
a transmission mode or a reception mode;
a transmission circuit for reading, when receiving a notice from a mobile terminal saying that a belonging request has been received, said agent advertisement from said memory, and then transmitting said notice to said mobile terminal via said wireless transmission/reception circuit and via said transmission/reception switching circuit; and
a terminal belonging management circuit for notifying, when detecting receiving a belonging request from said mobile terminal, said transmission circuit of the reception.

6. The system defined in claim 1, wherein said mobile terminal comprises:
a wireless transmission/reception circuit being an interface circuit that connects said mobile terminal to said wireless base stations by wireless;
a transmission/reception switching circuit being a circuit that switches said wireless transmission/reception circuit to a wireless transmission mode or a wireless reception mode;
a belonging processing circuit for transmitting, when receiving a notice saying that signals periodically transmitted from a wireless base station have been detected, a belonging request to said wireless base station via said wireless transmission/reception circuit and via said transmission/reception switching circuit; and
a base station decision circuit being a circuit that detects signals periodically transmitted from a wireless base station belonging to a self station, said base station detection circuit judging, when said signals are not detected, that said self station has moved outside the radio cell of said wireless base station and notifying, when signals periodically transmitted from other wireless base station are detected, said belonging processing circuit of the detection.

7. The system defined in claim 6, wherein said mobile terminal comprises:
an agent connection processing circuit for transmitting, when receiving a notice saying that reception of said agent information has been detected, a movement notice for said agent to a wireless base station via said wireless transmission/reception circuit and via said transmission/reception switching circuit; and
an agent advertisement reception circuit being a circuit that detects reception of said agent information, said agent advertisement reception circuit notifying, when detecting reception of said agent information, said agent connection processing circuit of the detection, and outputting a request for changing the network setting of a terminal connected to said mobile terminal based on said agent information, to a network setting changing circuit of said terminal.

8. A method of controlling a wireless LAN system, said wireless LAN system including a plurality of communications networks connected to each other; base stations communications for periodically sending signals within a wireless cell, at least one of said base stations being disposed in each of networks; a mobile terminal for transmitting, when newly receiving said signals, a belonging request to a base station which has sent said signals, and connecting, when receiving permission for belonging from said wireless base station, said mobile terminal to said wireless base station, thus conducing communications; and agents each for distributing an agent advertisement onto said communications networks and managing, the location of said mobile terminal based on a movement notice transmitted from said mobile terminal after said mobile terminal receives said agent information, each of agents being disposed in each of said communications networks; said method comprising the steps of:
storing said agent information into each of said base stations, based on said agent advertisement distributed on said communications network; and
when each of said wireless base stations receives a belonging request from said mobile terminal and permits belonging of said mobile terminal, transmitting said agent information to be stored to said mobile terminal from each of said wireless base stations, together with said permission for belonging.
